(19) United States
(12) Patent Application Publication
(10) Pub. No.: US 2024/0152947 A1
(43) Pub. Date: May 9, 2024

(54) SYSTEMS AND METHODS FOR MAILSTREAM POSTAGE PRESERVATION

(71) Applicant: DMT Solutions Global Corporation, Danbury, CT (US)

(72) Inventors: Eddy Edel, New Milford, CT (US); Gregory P. Skinger, Southbury, CT (US); Andrew Bruce, Woodbury, CT (US)

(21) Appl. No.: 18/387,648

(22) Filed: Nov. 7, 2023

Related U.S. Application Data
(60) Provisional application No. 63/423,147, filed on Nov. 7, 2022.

(51) Int. Cl. G06Q 30/0208; G06K 15/00

(52) U.S. Cl. CPC G06Q 30/0208; G06K 15/408

(57) ABSTRACT

The present invention provides systems and methods for preserving postage discounts in a mailstream location, reprinting removed mailsheets, and returning mailpieces to their originally intended location. Because the sequence of the mailstream is restored, postage discounts based on print stream location are preserved and the correct mailsheets are grouped together to qualify for the postage discount. Advantageously, restoring the sequence of the mailstream in place is more efficient than through a secondary workflow.

### CROSS-REFERENCE TO RELATED APPLICATIONS

This application claims priority to, and the benefit of, U.S. Provisional Application No. 63/423,147, filed Nov. 7, 2022, the content of which is incorporated by reference herein in its entirety.

### FIELD OF THE INVENTION

The present invention relates generally to mail printing and postage processing, and, more particularly, to systems and methods for identifying a faulty mailsheet of a mailpiece in a given mailstream and reprinting and reinserting the reprinted faulty mailsheet (and subsequent mailpiece formed therefrom) within the mailstream in a predefined mailstream sort to thereby preserve a calculated postal discount for the mailpiece to which the faulty mailsheet belongs.

### BACKGROUND

Automated mailing industry workflow is primarily designed to monitor and control document production equipment, such as high volume printers, inserting machines, and mail sorting machines. Typically, the starting point for a document production process begins with a stream of print data generated by the organization wishing to create the mailing, including recipients and mailing addresses. The print streams can be manipulated using software that allows users to change and/or enhance the content of documents and to further optimize the postage of a mailstream by integrating a postal service's delivery postage discount rules, which can be used for bulk mailings and the like. Once print stream manipulations are completed, the print stream may be sent to a mailpiece fabrication system.

Mailpiece fabrication systems are analogous to automated assembly equipment in that sheets, inserts and envelopes are conveyed along a feed path and assembled in, or at, various modules of the mailpiece fabrication system. For example, the typical inserter system resembles a manufacturing assembly line. Sheets and other raw materials (e.g., other sheets, enclosures, and envelopes) enter the inserter system as inputs. Then, a plurality of different modules or workstations in the inserter system cooperatively operate to process the sheets until a finished mailpiece is produced. The exact configuration of each inserter system depends upon the needs of each particular customer or installation.

Typically, inserter systems prepare mailpieces by gathering collations of documents on a conveyor. The collations are then transported on the conveyor to an insertion station where they are automatically inserted into premade envelopes or wrapped. The completed envelopes or wraps are removed from the inserter station for further processing. Further processing may include, but is not limited to, automated closing and sealing of the envelope, diversion from the mailstream for manual handling (e.g., for non-compliant mailsheets within a given mailpiece), applying postage to the finished mailpieces, and finally sorting and stacking the envelopes.

Each collation of documents processed by the inserter system typically includes a control document having coded control or reference marks printed thereon. Scanners may be located throughout the inserter system to sense documents and to allow control over processing of a particular mailpiece. The coded marks may include, for example, machine readable labels, such as a barcode or the like.

A control system may be coupled to the inserter system's modular components. The control system may generally store data files identifying how individual mailpieces should be processed. Such data files are typically linked to individual mailpieces by the coded marks included on associated control documents. As a collation passes through the inserter system, the coded marks on a given control document are scanned and the control system directs the modular components to assemble the mailpiece based on a predefined order.

Once a finished mailpiece has been formed by the inserter system, it may be stacked and provided to a carrier service, such as the U.S. Postal Service, for delivery. Often, in order to receive postal discounts, it is advantageous to sort the outgoing mail in accordance postal regulations. Such postal optimization is typically done upstream of the inserter system in the print data or downstream of the inserter system with a sortation device, such as a sorter sold under the trade name VANTAGE by BlueCrest Inc (with a headquarters in Danbury CT) or inline to the inserter system.

Current mailpiece fabrication systems utilize sensing devices at the various stages of the inserting process in an attempt to identify the occurrence of errors and mishandling of documents. When an error is found within at a given stage, the inserter system typically provides a notification of errors so that corrective action may be taken. For example, in some systems, a notification error may prompt manual corrective action (i.e., alert an operator of the error, which in turn requires manual corrective action). In some systems, an identified faulty mailsheet may be diverted for later correction or reprinting through a different print stream, process, and/or possibly a completely different workflow.

Accordingly, the faulty document identification and remediation techniques of current systems have drawbacks and limitations. In particular, such processes typically result in an increase in the overall mailstream costs as a result of reprocessing costs for a given mailpiece, as well as the potential for a given mailpiece to have a higher postage cost as it may no longer qualify for the initial and calculated postage discounts as a result of a faulty mailsheet no longer being grouped with corresponding mailsheets in a given mailpiece.

### SUMMARY

The present invention provides systems and methods for preserving postage discounts in a mailstream. In particular, the present invention is directed to a system and method for identifying a faulty mailpiece in a given mailstream, which includes identifying one or more faulty mailsheets in a mailpiece and subsequently removing the identified mailsheet (and other mailsheets at least associated with the mailpiece to which the faulty mailsheet belongs) from the mailstream. The identified faulty mailsheets can then be reprinted and further reinserted back into an original intended location within mailstream sort to thereby preserve a calculated postal discount for the faulty mailpiece. Accordingly, by correcting errors in the mailstream, rather than through a secondary workflow, postage discounts based on mailstream location are preserved and the correct mailsheets are grouped together such that associated mailpieces qualify for the postage discount.

One aspect of the invention is directed to a method for preserving postage discounts in a mailstream. The method includes obtaining a plurality of sequentially ordered printed mailsheets in a mailstream, wherein each mailsheet has a unique identifier of its order within the mailstream. The method further includes removing one or more of the plurality of mailsheets identified as having an error. In turn, the identifier on the one or more removed mailsheets can then used to identify the removed mailsheets and their respective location/order within the mailstream. The removed mailsheets may then be reprinted, for example with an inline printer and subsequently returned to their order within the mailstream. As such, returning a reprinted mailsheet to its order within the mailstream advantageously preserves the available postage discount for the mailsheet.

It should be noted that mailsheets may be removed from the mailstream for any reason. For example, one or more mailsheets may be removed due to errors identified in the mailsheet. A mailsheet error may comprise damage to the mailsheet, for example, such as damage from a jam within the mailstream or from initial printing of the mailsheet. Other errors may include a printing error on the mailsheet itself (i.e., misprinted information or the like).

Advantageously, in one embodiment, mailpieces within a given mailstream that fall either immediately before and/or immediately after a mailpiece in which a mailsheet was removed (i.e., a faulty mailpiece) may be marked along an edge thereof so as to provide a visual indication to an operator as to the location that a reprinted mailpiece should be returned in the mailstream.

Accordingly, in one embodiment, the step of returning a reprinted mailsheet to its order in the mailstream may comprise placing the reprinted mailsheet into a carrier (i.e., envelope, wrap, container, etc.) to form a reprinted mailpiece and placing the reprinted mailpiece between the corresponding marked mailpieces. In some embodiments, the step of returning a reprinted mailsheet to its order in the mailstream may include placing the reprinted mailsheet into a carrier to form a reprinted mailpiece and placing the reprinted mailpiece immediately after the previous mailpiece created from a mailsheet that was not removed from the mailstream Yet still, in some embodiments, all mailpieces within a mailstream that follow the faulty mailpiece may be removed and subsequently reprinted along with the reprinting of the faulty mailpiece, such that the mailstream reenters the inserter system (with newly reprinted mailsheets) and mailpieces are recreated.

Mailsheets may be removed from the mailstream by any method for managing mailstreams. For example, the step of removing one or mailsheets may comprise first diverting the one or more mailsheets from the mailstream and/or the one or more mailsheets immediately preceding or immediately following a removed mailsheet. For example, all the of the mailsheets immediately preceding or immediately following a removed mailsheet that would be part of the same mailpiece as the removed mailsheet, or all of the mailsheets that would be part of a preceding or following mailpiece, may be removed. As a result, both the to-be removed mailsheet and the immediately preceding or following mailsheets that form a mailpiece are removed from the mailstream. This allows for both the to-be removed mailsheet and the mailsheets that form a mailpiece ahead of or following that mailsheet to be reprinted and returned to the mailstream with minimal delay.

Advantageously, the step of returning the mailsheet may comprise returning the mailsheet to a postal tray and/or location within a postal tray to qualify for an available postage discount.

It is understood that methods of the invention may be used to remove mailsheets, collations of mailsheets, or mailpieces from the mailstream. Advantageously, the mailsheets from any removed collation of mailsheets or mailpieces may be immediately reprinted, repackaged into mailpieces, and returned to their location in the mailstream.

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram schematic of a document inserter system in which the systems and methods of the present invention can utilize for carrying out the mailstream postage preservation described herein.

FIG. 2 is a block diagram schematic illustrating modules for use in the document inserter system of FIG. 1 and for performing the methods of the present invention.

FIG. 3 is a flow chart of an exemplary method of the present invention.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present invention is directed to systems and methods for identifying a faulty mailsheet within a given mailstream and reprinting and reinserting the faulty mailsheet within the mailstream in a predefined mailstream sort to thereby preserve a calculated postal discount for a mailpiece to which the faulty mailsheet belongs. Accordingly, the present invention allows for the preservation of postage discounts in a mailstream by returning removed mailsheets to their originally intended location. In particular, because mailsheets are returned in place, rather than through a secondary workflow (for example, sending the reprinted mailsheets separately), postage discounts based on recipient's location are preserved and the correct mailsheets are grouped together to qualify for the postage discount.

Again, by maintaining the order of the mailstream, the postage discounts corresponding to a given mail carrier may be maintained by the systems and methods of the present disclosure. For example, any given carrier may frequently provide discounts to mailers who presort mail. The discounts may vary from country to country and are often dependent on the level of presorting. The more specificity with which the mail has been correctly sorted in relation to delivery by the postal service or carrier, the greater the discount. For example, through July 2022, when mailers presorted mail before presentation to the United States Postal Service (USPS), the postal discounts from the full postal charge for first class mail presently provided to the mailer by the USPS is as high as 15.4 cents per mailpiece. This discount would translate into savings for the mailer of as much as $6,160 per hour in postage alone if a sorter was processing 40,000 mail pieces per hour.

As used herein, mailsheets generally refer to documents to be prepared for mailing. Mailsheets may be stuffed, inserted, or wrapped into, for example, envelopes, wraps, packaging, and/or boxes. Once packaged for mailing, one or more mailsheets in a given envelope, wrap, package, etc., are referred to as a mailpiece. As such, a single mailsheet may be placed into a single carrier to form a mailpiece or multiple mailsheets may be placed into a single carrier to form a mailpiece.

Mailsheets may be removed from the mailstream for any reason. For example, mailsheets may be removed based on user input. Mailsheets may also be removed for comprising an error, for example a physical error. Mailsheet errors may include any form of physical error present on the mailsheet. For example, common mailsheet errors include physical damage to mailsheets from jams encountered during a workflow process. Other errors may include a printing error on the mailsheet itself (i.e., misprinted information or the like).

It should be noted that each mailsheet may be marked with a unique identifier that provides an indication of a respective mailsheet's order within the mailstream. The identifier may include, but is not limited to, any type of identifying information, such as full text, coded text, an image, barcodes, RFID codes, or the like. Accordingly, the systems and methods of the present invention may further utilize scanners or the like for reading an identifier. For example, a scanner, such as a handheld scanner, may be used to read an identifier. Accordingly, the scanner may be a scanner for identifying text and/or images and such scanning data may be used in the identification process (i.e., identifying a faulty mailsheet) and providing such scanning data to be used for subsequent removing, reprinting, and/or reinserting steps, as described in greater detail herein.

It should further be noted that exemplary United States carrier services for use with systems and methods of the present invention include, but are not limited to, the U.S. Postal Service, UPS, and FedEx. However, any carrier service may be used, particularly those carrier services that provide postal discounts, such as, for example Canadian, European, an Asian carrier services (i.e., Canada Post, Deutsche Post, Royal Mail, and La Poste). As such, any postal service that provides a discount may benefit from the systems and methods of the present invention.

Accordingly, the systems and methods of the present invention may be configured so as to meet the rules of any carrier service and any local postage service. For example, manifest-based systems may benefit from the systems and methods of the present invention, by maintaining the grouping of all mailsheets that are to be sent to a single recipient. Systems and methods of the present invention may also take advantage of any postage class, such as, for example, standard mail, priority mail, express mail, first-class mail, ground, international, same-day, 2-day delivery, and/or 3-day delivery. Moreover, the systems and methods of the present invention may be used in situations in which a single mailstream is to be grouped and to be shipped by different carrier services.

As described in greater detail herein, the systems and methods of the present invention can utilize a production mail inserter, allowing for faulty mailsheet identification, removal/diversion, reprinting, and reinsertion to occur for a given mailstream being processed via a production mail inserter. For example, the systems and methods of the present invention may be use modular inserter platforms, including, but not limited to, any one of the EVOLUTION™, MAILSTREAM EVOLUTION™, RIVAL™, and EPIC™ inserter platforms available from DMT Solutions Global Corporation dba BlueCrest (Danbury, CT).

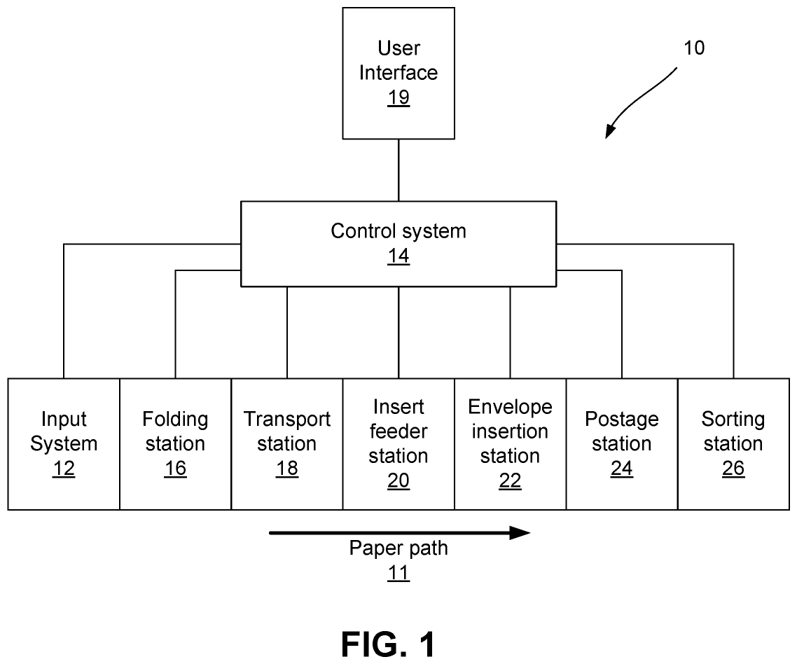

FIG. 1 is a block diagram schematic of a document inserter system 10 in which the systems and methods of the present invention can utilize for carrying out the mailstream postage preservation described herein.

The document inserting system 10 includes several stations or modules. The document insertion system 10 is illustrative and many other configurations may be utilized. The system 10 includes an input system 12 that feeds paper sheets from a paper web to an accumulating station that accumulates the sheets of paper in collation packets. In some embodiments, only a single sheet of a collation is coded (the control document), which coded information can be one input into the control system 14. The control system includes a processor configured to execute instructions that control the processing of documents in the various stations of the mass mailing inserter system 10. For example, in the embodiments described herein, a mailstream may be ordered by the control system 14 which can be used for identifying and sorting mailsheets for available postage discounts. It should be noted that the mailstream may be manually set prior to initial printing of the mailstream.

The system 10 may include a user interface 19 for controlling one or more user inputs and displaying one or more outputs from the system 10, allowing a user to interact with and control the operation of the system, can be physically connected to the system or can be located remotely. The user interface 19 can include a screen such as a touchscreen configured to display operating conditions and parameters of the inserter system 10 to a user. The user interface 19 can include other input devices such as a keyboard/keypad or a mouse.

The input system 12 is configured to feed sheets in a paper path, as indicated by arrow 11, along what is known as the main deck of inserter system 10. After sheets are accumulated into collations by input system 12, the collations are folded in folding station 16 and the folded collations are then conveyed to a transport station 18, preferably operative to perform buffering operations for maintaining a proper timing scheme for the processing of documents in insertion system 10.

Each sheet collation is fed from the transport station 18 to an insert feeder station 20. It should be noted that an inserter system 10 may include a plurality of feeder stations, but for clarity, only a single insert feeder 20 is shown. The insert feeder station 20 may be configured to convey an insert (e.g., an advertisement or the like) from a supply tray to the main deck of inserter system 10 so as to be combined with the sheet collation conveying along the main deck. The sheet collation along with nested insert(s) are next conveyed into envelope insertion station 22 that is operative to open an unsealed envelope and insert the collation into the opening of the envelope.

The filled envelope may then be conveyed to a station for sealing and/or rearranging the filled envelope for subsequent processing. For example, in some embodiments, the system 10 may include a sealing and flipping station that is operable to wet the adhesive substance on the flap of the envelope, rotate the envelope into a face-up orientation, and seal the envelope by pressing the flap against the body of the envelope. The filled and sealed envelope is then conveyed to postage station 24. Finally, the envelope is conveyed to sorting station 26 that sorts the envelopes.

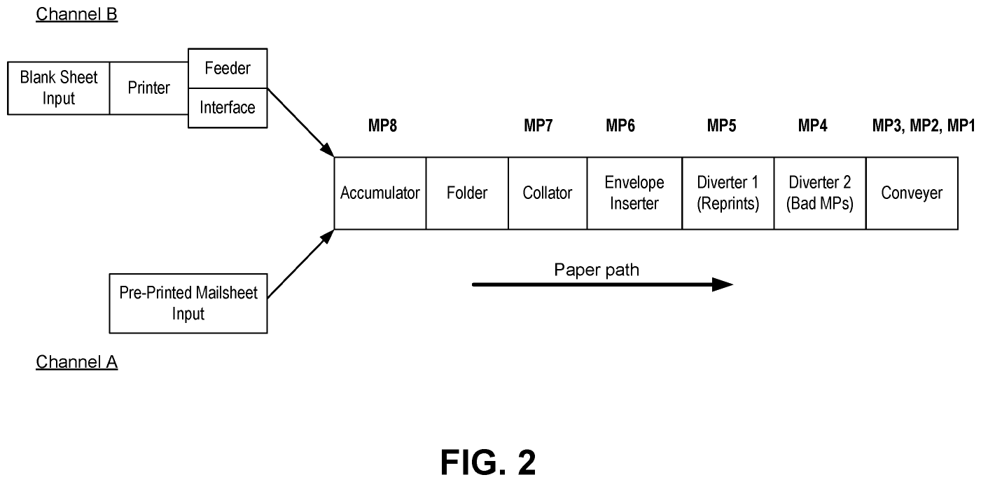

FIG. 2 is a block diagram schematic illustrating modules for use in the document inserter system of FIG. 1 and for performing the methods of the present invention. As shown, the inserter system 10 may include additional stations/modules for performing additional tasks. For example, mailpiece inserter systems may include a variety of apparatus/modules for conveying and processing a substrate/sheet material along the feed path, in addition to those stations/modules described herein. For example, an inserter system consistent with the present disclosure may further include apparatus/modules for: (i) accumulating printed content to form a multi-sheet collation in an “accumulator”; (ii) folding the content to produce a variety of fold configurations such as a C-fold, Z-fold, bi-fold and gate fold, in a “folder”; and (iii) gathering collations of the folded content in a “collator”.

As illustrated, the accumulator module is configured to receive content (i.e., sheets of printed documents, referred to herein as mailsheets) from at least two different sources. For example, a first channel (Channel A) includes an input configured to feed a primary source of mailsheets (in the form of pre-printed mailsheets) to the accumulator. For example, the input of Channel A may include a cutter (configured to cut a web of pre-printed material into predefined sizes of mailsheets) or a sheet feeder (for feeding pre-printed mailsheets) for a given job. The accumulator module is configured to combine one or more mailsheets to form a mailpiece. In another embodiment, a second channel (Channel B) includes an input acting as both a primary source of mailsheets and the source of reprinted mailsheets, as will be described in greater detail herein. For example, in the event that Channel A is disabled or simply not included as part of the inserter system, Channel B is able to provide all mailsheets for a given job (including initial mailsheets and any reprinted mailsheets required due to faulty mailsheets being identified). Yet still, in some embodiments, both Channels A and B may be incorporated and relied upon for a given job. For example, while the initial source of mailsheets may be provided by Channel A, should any given mailsheet become damaged or be identified as having any other type of error (i.e., misprint or the like), reprinted versions of such mailsheets can be provided via Channel B.

Generally, a mailstream enters the inserter system, with each printed mailsheet pre-ordered according to an order that allows the mailstream to take advantage of available postage discounts. For example, a given mailstream may include a plurality of sequentially ordered printed mailsheets, wherein each mailsheet has a unique identifier indicating its order within the mailstream. In the event that an error is detected with a given mailsheet, the faulty mailsheet is diverted from further processing via a diverter (e.g., a divert gate or the like). Accordingly, a scanner may be used for identifying any faulty mailsheets that have been diverted, including identifying the error and the specific order of the faulty mailsheet within the given mailstream. In turn, the faulty mailsheets may be reprinted (via printer of Channel B) and then reinserted into the accumulator to be processed and packaged into a mailpiece and subsequently placed back into their order within the mailstream to form a final mailstream which qualifies for initially calculated postage discounts.

For example, as illustrated in FIG. 2, there are at least two possible operating modes when reprinting faulty mailsheets. In a first operating mode, when a mailsheet of a given mailpiece is identified as having an error, that given mailpiece is identified as having an error. Accordingly, when a mailpiece has been deemed to have an error, the mailpiece is diverted and removed from the mailstream in diverter 2 (see mailpiece 4 “MP4”). The inline printer (of Channel B) is configured to reprint the one or more faulty mailsheets for MP4 which is sent to the accumulator behind mailpiece 8 “MP8”. The other mailpieces in the system (mailpiece 5 “MP5” through MP8) proceed to the conveyer as not having any errors and thus deemed as being “good”. The reprinted MP4 is then outsorted to diverter 1, in which an operator is then able to remove reprinted MP4 from diverter 1 and manually places it back within the proper sequence within the mailstream (between MP5 and MP3) on the conveyer. In this instance, as previously described herein, the system may include a marking module configured to physically mark mailpieces (along an edge thereof) immediately before and immediately after a diverted mailpiece to thereby provide an operator with a visual indication of the location within the mailstream where a diverted mailpiece should be returned once reprinted and packaged into a mailpiece.

In a second operating mode, when a mailsheet of a given mailpiece is identified as having an error, that given mailpiece is identified as having an error, and thus diverted to diverter 2 and removed from the mailstream. In turn, all other mailpieces following that “bad” mailpiece within the mailstream are also deemed as being “bad” simply based on the fact that they sequentially follow the “bad” mailpiece. Accordingly, in the illustrated example of FIG. 2, in the event that MP4 is deemed “bad” as a result of an associated mailsheet having an error, then MP5 through MP8 are also deemed to be “bad” and diverted to diverter 2. Thus, the inline printer is then commanded to reprint all mailsheets for MP4 through MP8 and feed that mailstream back into the accumulator, at which point, reprinted MP4 through MP8 are then passed along to the conveyer to thereby join MP1 through MP3 and complete the mailstream.

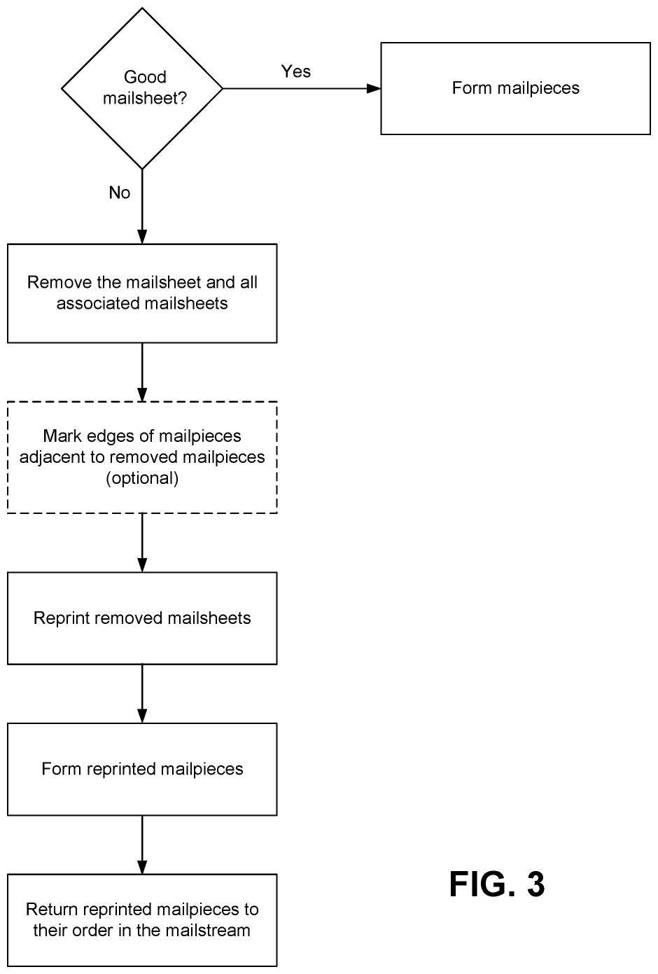

FIG. 3 is a flow chart of an exemplary method of the present invention. Within a given mailstream, mailsheets are identified as either having errors or having no errors. In the event a given set of mailsheets does not contain any mailsheets having errors (i.e., mailsheets in a given set are error-free), that given set may then move along the workflow process and be formed into a corresponding mailpiece. In the event that a mailsheet is identified as having an error, than that mailsheet is removed from the mailstream (including removal of all mailsheets of the associated mailpiece to which the mailsheet having an error is associated with). Optionally, the movement of the mailstream may be placed on standby prior to entering preparation of the mailstream for packaging and/or mailing. A printer inline with the mailstream then reprints the faulty mailsheet(s).

Mailsheets within the main mailstream are packaged within a carrier into mailpieces. Reprinted mailsheets are also packaged within carrier into reprinted mailpieces. Reprinted mailpieces are then returned to their location within the mailstream among the mailpieces. Advantageously, mailpieces adjacent to removed mailsheets may be marked along their edge to aide in returned reprinted mailpieces to their location in the mailstream.

Advantageously, the systems and methods of the invention allow users to complete jobs in the workflow in the way in which the user intended to process the workflow. The systems and methods also eliminate inefficiencies associated with reprinting mailsheets with errors separately through a separate reprint workflow later in the day or in the week following the initial workflow. Furthermore, systems and methods of the present invention allow for the immediate correction of errors. The systems and methods of the present invention further allow users to protect the postage cost of the workflow by providing mail with an uninterrupted sequence. As such, mailpieces are able to consistently qualify for the maximum postal discount calculated for the workflow.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A method for preserving postage discounts in a mailstream, the method comprising:
obtaining a plurality of sequentially ordered printed mailsheets in a mailstream, wherein each mailsheet in the plurality has an identifier of its order within the mailstream;
removing one or more mailsheets from the mailstream;
using the identifier of the one or more removed mailsheets to identify the mailsheets and their order within the mailstream;
reprinting the one or more mailsheets removed from the mailstream; and
returning the reprinted one or more mailsheets to their order within the mailstream, wherein returning a reprinted mailsheet to its order within the mailstream preserves the available postage discount for the mailsheet.

2. The method of claim 1, wherein the one or more mailsheets are removed for containing one or more errors.

3. The method of claim 2, wherein the one or more errors comprise physical damage to the one or more mailsheets and/or misprinted text and/or graphics on the one or more mailsheets.

4. The method of claim 1, wherein defined sets of the plurality of mailsheets of the mailstream are placed into respective carriers to form corresponding mailpieces.

5. The method of claim 4, wherein the carrier may include at least one of an envelope, a package, a box, a container, and a wrap.

6. The method of claim 4, wherein the step of removing one or more mailsheets from the mailstream comprises removing one or more defined sets of the plurality of mailsheets that cooperatively form corresponding mailpieces, wherein at least one of the mailsheets of a defined set of mailsheets contains an error.

7. The method of claim 6, wherein the step of returning a reprinted mailsheet to its order within the mailstream comprises placing reprinted mailsheets into a carrier to form a reprinted mailpiece and placing the reprinted mailpiece to its order within the mailstream and immediately before and/or immediately after mailpieces that do not contain mailsheets that were removed.

8. The method of claim 7, wherein one or more mailpieces positioned within the mailstream immediately before and/or immediately after a mailpiece having the one or more removed mailsheets are marked along their respective edges.

9. The method of claim 8, wherein the step of placing a reprinted mailpiece to its order within the mailstream comprises placing the reprinted mailpiece between corresponding mailpieces having been marked along their respective edges.

10. The method of claim 1, wherein the step of returning a reprinted mailsheet to its order within the mailstream comprises returning the reprinted mailsheet to a postal tray and/or location within a postal tray to qualify for the available postage discount.

11. A method for preserving postage discounts in a mailstream, the method comprising:
obtaining a plurality of sequentially ordered printed mailsheets in a moving mailstream, wherein each mailsheet in the plurality has an identifier of its order within the mailstream;
identifying one or more mailsheets containing errors;
removing mailsheets from the mailstream, wherein at least some of the removed mailsheets contain errors;
placing the movement of the mailstream on standby;
using the identifier of the one or more removed mailsheets to identify the mailsheets with errors and their order within the mailstream;
reprinting the mailsheets removed from the mailstream;
returning the reprinted mailsheets to their order within the mailstream, wherein returning a mailsheet to its order within the mailstream preserves the available postage discount for the mailsheet; and
placing the movement of the mailstream off of standby.

12. The method of claim 11, wherein the one or more mailsheets are removed for containing an error.

13. The method of claim 12, wherein the error comprises physical damage to the one or more mailsheets and/or misprinted text and/or graphics on the one or more mailsheets

14. The method of claim 11, wherein defined sets of the plurality of mailsheets of the mailstream are placed into respective carriers to form corresponding mailpieces.

15. The method of claim 14, wherein the carrier may include at least one of an envelope, a package, a box, a container, and a wrap.

16. The method of claim 14, wherein the step of removing mailsheets from the mailstream comprises:
diverting, from the mailstream, a first set of mailsheets having at least one mailsheet containing an error; and
diverting, from the mailstream, all subsequent sets of mailsheets immediately following the first set of mailsheets.

17. The method of claim 16, wherein the step of reprinting the mailsheets removed from the mailstream comprises reprinting all sets of mailsheets diverted from the mailstream.

18. The method of claim 17, wherein the step of returning reprinted mailsheets to their order within the mailstream comprises placing the sets of reprinted mailsheets into respective carriers to form corresponding reprinted mailpieces and placing the reprinted mailpieces immediately after a previously formed mailpiece that does not contain mailsheets that were removed.

19. The method of claim 11, wherein the step of the reprinted mailsheets to their order within the mailstream comprises returning the reprinted mailsheets to a postal tray and/or location within a postal tray to qualify for the available postage discount.

20. A system for preserving postage discounts in a mailstream, the system comprising:
a mailstream comprising a plurality of sequentially ordered printed mailsheets, wherein each mailsheet in the plurality has an identifier of its order within the mailstream;
a divert gate for diverting one or more mailsheets from the mailstream, wherein at least some of the diverted mailsheets contain errors;
a scanner for identifying mailsheets in the divert gate containing errors and their order within the mailstream; and
a printer for reprinting mailsheets diverted from the mailstream and to then be returned to their order within the mailstream to thereby preserve the available postage discount for the mailsheet.

21. The system of claim 20, further comprising an optical module for identifying one or more mailsheets within the mailstream containing errors.

22. The system of claim 21, wherein the error comprises physical damage to the one or more mailsheets and/or misprinted text and/or graphics on the one or more mailsheets.

23. The system of claim 20, further comprising a packaging module for packaging defined sets of mailsheets of the mailstream into respective mailpieces.

24. The system of claim 23, further comprising a marking module configured to mark mailpieces positioned within the mailstream immediately before and/or immediately after a mailpiece having the one or more diverted mailsheets to thereby indicate the location within the mailstream where a diverted mailsheet should be returned once reprinted and packaged into a corresponding mailpiece.

25. The system of the claim 24, wherein the mailpieces positioned within the mailstream immediately before and/or immediately after a mailpiece having the one or more diverted mailsheets are marked along their edge.

26. The system of claim 23, wherein the one or more diverted mailsheets comprise a set of mailsheets having at least one mailsheet containing an error such that the printer is configured to reprint the set of diverted mailsheets to thereby be placed into a carrier and form a corresponding reprinted mailpiece be returned to is order within the mailstream.

27. The system of claim 23, wherein the divert gate is configured to:
divert, from the mailstream, a first set of mailsheets having at least one mailsheet containing an error; and
diverting, from the mailstream, all subsequent sets of mailsheets immediately following the first set of mailsheets.

28. The system of claim 27, wherein the printer is configured to:
reprint the first set of diverted mailsheets to thereby be placed into a carrier and form a corresponding reprinted first mailpiece; and
reprint all subsequent sets of diverted mailsheets to thereby be placed into respective carriers and form corresponding reprinted subsequent mailpieces.

29. The system of claim 20, further comprising one or more postal trays, wherein a reprinted mailsheet may be returned to a postal tray and/or location within a postal tray to qualify for an available postage discount.
